(19) United States
(12) Patent Application Publication
(10) Pub. No.: US 2018/0194291 A1
(43) Pub. Date: Jul. 12, 2018

(54) LINKAGE ASSEMBLY FOR RETRACTABLE LADDER ARRANGEMENT

(71) Applicant: THE SMART 2011 TRUST, Sandton (ZA)

(72) Inventor: George Grammatikos, Middleburg (ZA)

(21) Appl. No.: 15/657,952

(22) Filed: Jul. 24, 2017

Related U.S. Application Data
(63) Continuation-in-part of application No. PCT/ZA2016/050003, filed on Jan. 25, 2016.

(30) Foreign Application Priority Data
Jan. 23, 2015 (ZA) 2015/00494

(51) Int. Cl. B60R 3/02

(52) U.S. Cl. CPC B60R 3/02; E04F 11/066

(57) ABSTRACT

A linkage assembly in accordance with the invention which includes a plurality of elongate linkage members 12, a first, second and third connecting means for connecting and allowing pivotal displacement between proximal end regions of a first 14 and second 16 linkage members, a step support connecting means for connecting and allowing pivotal displacement between the first 14 and fourth 18 linkage members, inwardly the second connecting means and for supporting a stepping formation 20 thereon.

This application is a continuation-in-part filing claiming the benefit of PCT/ZA2016/050003 filed 25 Jan. 2016, the disclosure of which is herein incorporated by reference.

### FIELD OF THE INVENTION

This invention relates to a linkage assembly for a retractable ladder arrangement suitable for providing access to for example, a heavy duty mining vehicle and to a retractable ladder arrangement for a heavy duty mining vehicle or the like.

### SUMMARY OF THE INVENTION

According to a first aspect of the invention there is provided a linkage assembly for a retractable ladder arrangement which includes:

a plurality of elongate linkage members;

a first connecting arrangement for connecting and allowing pivotal displacement between proximal end regions of a first and a second linkage member;

a second connecting arrangement for connecting and allowing pivotal displacement between distal end regions of the first and a third linkage member;

a step support connecting arrangement for connecting the first and a fourth linkage member inwardly the second connecting arrangement and for providing a stepping formation for a user, the step support connecting arrangement including a shaft having a first portion which is shaped to be received by and inhibit relative pivotal displacement between the fourth linkage member and the stepping formation during extension and retraction of the retractable ladder arrangement and a second portion shaped to be received by and allow pivotal displacement between the first and fourth linkage members; and

a third connecting arrangement for connecting and allowing pivotal displacement between the first and a fifth linkage member intermediate the first and step support connecting arrangement.

The elongate linkage members may include receiving formations for receiving the various connecting arrangements therein. The receiving formations may be in the form of apertures defined in the linkage members. The apertures may be of any conventional geometric shape, typically generally circular to allow pivotal displacement between the first and second, first and third, first and fourth, and first and fifth linkage members respectively and non-circular to inhibit pivotal displacement between the fourth linkage member and the step support connecting arrangement.

The first, second and third connecting arrangements may have shaft portions which may be configured to be received complementally the apertures in the respective corresponding linkage members to allow relative pivotal displacement therebetween. The connecting arrangements may include a retaining member, typically in the form of a bolt, for retaining the shafts in the apertures. The connecting arrangements may include bearing assemblies which are shaped and configured to be arranged between the shafts and apertures to improve pivotal displacement between the respective linkages and shafts. The connecting arrangements may include spacers, typically in the form of washers or rings, for spacing the respective corresponding linkage members apart and to facilitate retention of the bearing assemblies in the apertures. The connecting arrangements may include sealing members arranged within corresponding grooves or recesses in the linkage members surrounding the apertures. It is to be appreciated that the sealing member may be in the form of a dust seal and may be manufactured out of rubber, plastic, metal or any other suitable material.

The second to fifth elongate linkage members may include a step support aperture for receiving the first portion of the shaft of the step support connecting arrangement and which may be configured to inhibit relative displacement between the fourth linkage member and the stepping formation. The step support aperture for receiving the step support connecting arrangement may have a non-circular cross-section, typically being generally hexagonal.

The first portion of the shaft of the step support connecting arrangement may be configured to be received by the step support aperture of the fourth linkage member and a second portion configured to be received by the third aperture of the first linkage member. The first portion of the shaft may be of any suitable non-circular geometric shape in cross section, typically of hexagonal cross section. The stepping formation may be securable to the first portion of the shaft via any suitable securing member such as a screw threaded bolt assembly.

The second portion of the shaft may typically be of circular cross section to permit relative pivotal displacement of the first linkage member and the stepping formation.

The step support connecting arrangement may include a retaining member for retaining the shaft in position in the apertures of the first and fourth linkage members. The step support connecting arrangement may include a bearing which may be shaped and configured to be arranged between the second portion of the shaft and the aperture of the first linkage member to improve pivotal displacement therebetween. The step support connecting arrangement may include a spacer element, typically in the form of a washer or ring, for spacing the first and fourth linkage members apart. The step support connecting arrangement may include sealing members arranged within corresponding grooves or recesses in the linkage members surrounding the apertures. It is to be appreciated that the sealing member may be in the form of a dust seal and may be manufactured out of rubber, plastic, metal or any other suitable material.

According to a second aspect of the invention, there is provided a retractable ladder arrangement for a vehicle, which retractable ladder arrangement includes:

a plurality of linkage assemblies as hereinbefore described which are connected in an end-to-end configuration;

a primary displacement means for displacing the linkage assemblies between a collapsed retracted condition and an extended condition;

a coupling for coupling the linkage assemblies to the primary displacement means; and

a controller for controlling the primary displacement means.

The primary displacement means may be in the form of any suitable motor which may be energised by an energy source from a motor vehicle. The electric source may be AC or DC. The displacement means may include a drive means. The drive means may be in the form of a motor and gearbox arrangement. The motor may be pneumatically or hydraulically powered. The drive means may include a coupling means for coupling the gearbox to the motor.

An auxiliary drive means is provided for the gearbox in the event that the motor is not energized. The auxiliary drive means displaces the gearbox when the motor is inoperable.

The auxiliary drive means may include a pressure vessel arranged in communication with the motor vehicle for pressurizing the vessel when the vehicle is in operation. The auxiliary drive means may be coupled with the gearbox.

The auxiliary drive means may include an activation means which may include a valve. The auxiliary drive means may be activated to drive the gearbox.

The ladder arrangement may include a deactivating means located at the motor which may be in the form of a pressure sensor. The pressure sensor may inhibit displacement of the ladder arrangement when there is a predetermined resistance provided to displacement of the linkages.

The control means may be arranged in a cab of the motor vehicle. The displacement means may be controlled by a—remote control means located on the outside of the cab of the motor vehicle. Typically, the remote control may be located in a position which permits a user access to the remote control means from a ground surface. The remote control means may include a display for displaying the condition of the stepping formations, typically in the form of a touchscreen. The touchscreen may be protected by a protective cover. The protective cover may be manufactured from plastic, glass, polyvinyl chloride or any other suitable material.

The control means may be configured to be in communication with a park brake of the motor vehicle such that when the park brake is activated or deactivated the linkage members and stepping formations are extended or retracted respectively.

Hand grips may be mountable on the linkage members.

According to a further aspect of the invention there is provided a securing means for securing the ladder arrangement to a vehicle, in order for the ladder to extend downwardly from the vehicle when the ladder is in the extended open position, and to be retracted towards a cabin of the vehicle when the ladder arrangement is displaced to the collapsed retracted condition.

A secondary displacement means may be provided for allowing the ladder arrangement to be displaceable to a stowage position once the ladder arrangement has been displaced to the retracted condition. Preferably the retracted ladder arrangement is pivoted into the stowage position.

### DETAILED DESCRIPTION OF THE DRAWINGS

A linkage assembly for a retractable ladder arrangement for a heavy duty mining vehicle or the like and retractable ladder for a heavy duty mining vehicle or the like in accordance with the invention will now be described by way of example with reference to the accompanying drawings.

In the drawings:

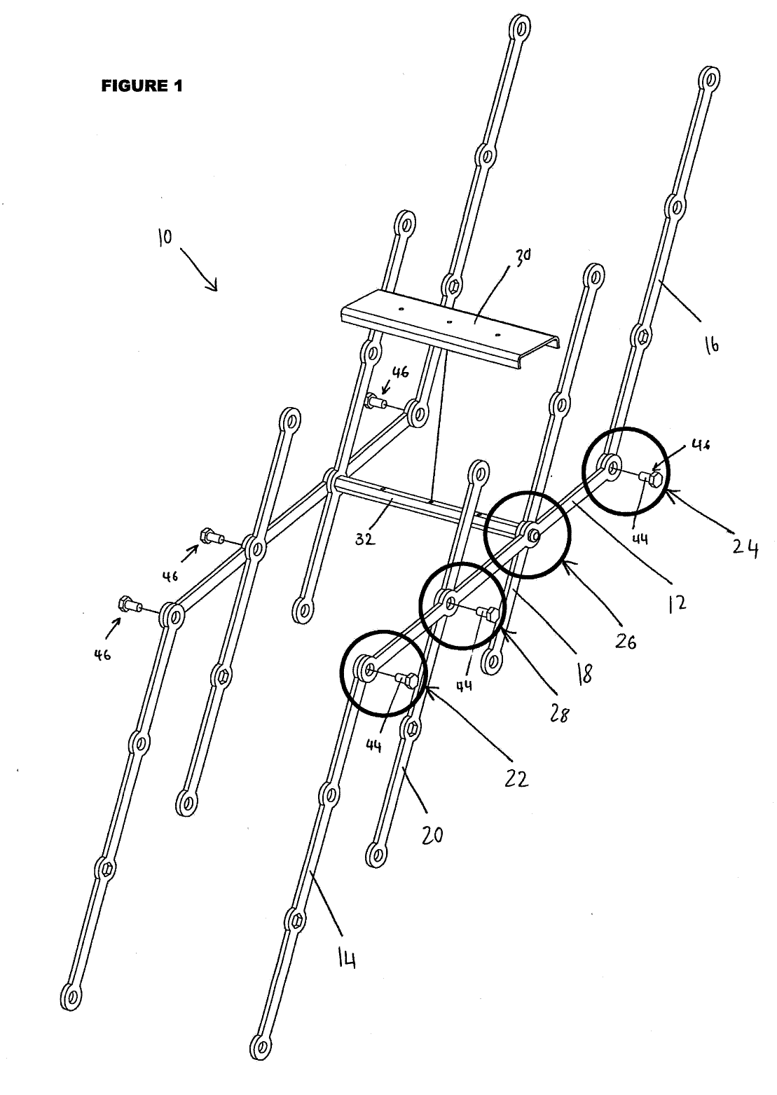

FIG. 1 shows a three-dimensional schematic of a linkage assembly in accordance with the invention;

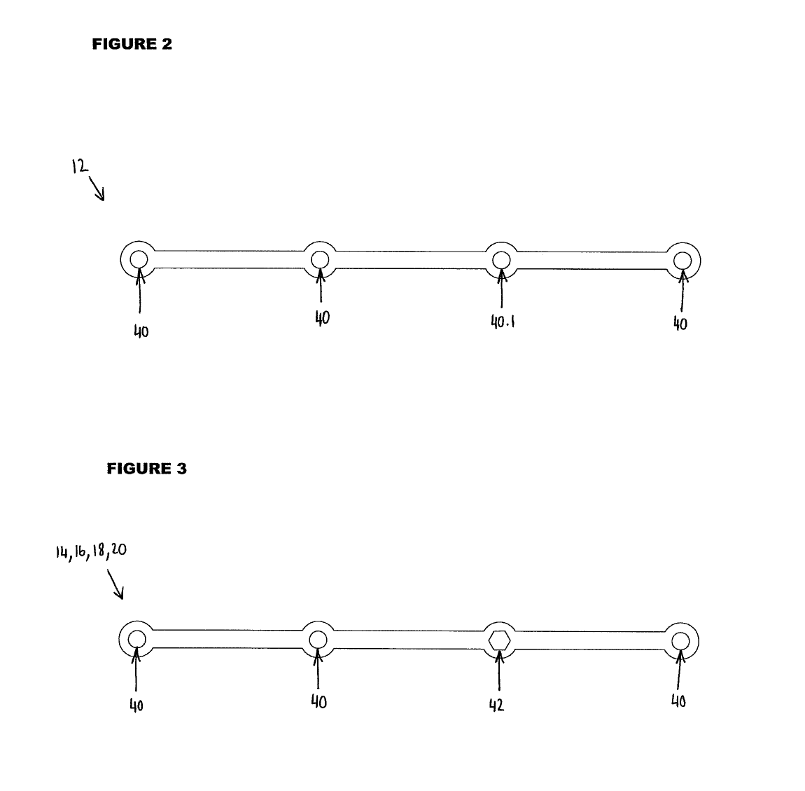

FIGS. 2 and 3 show enlarged schematics of elongate linkage members of the linkage assembly shown in FIG. 1;

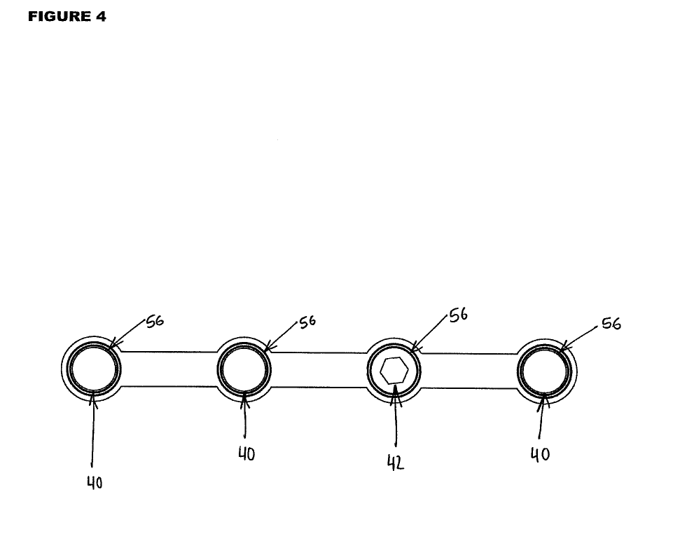

FIG. 4 shows a detailed schematic of FIG. 3;

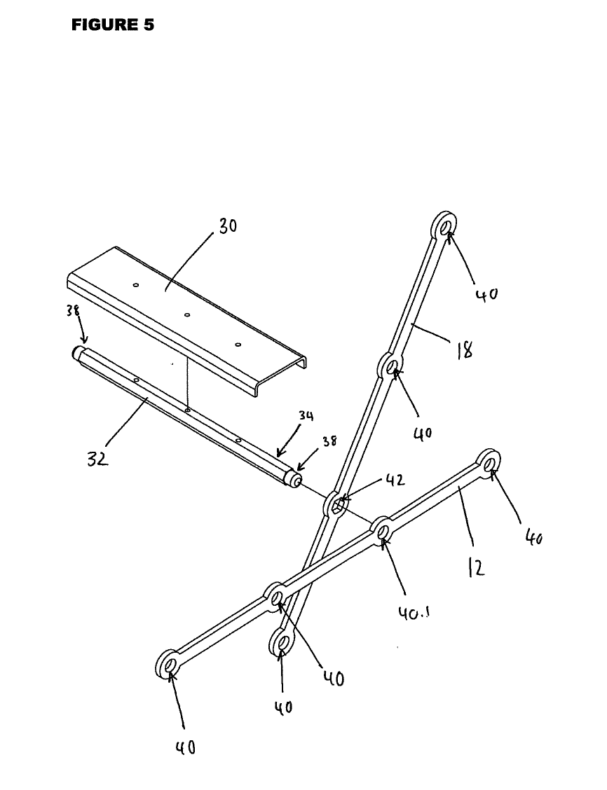

FIG. 5 shows an exploded view of a portion of the linkage assembly shown in FIG. 1;

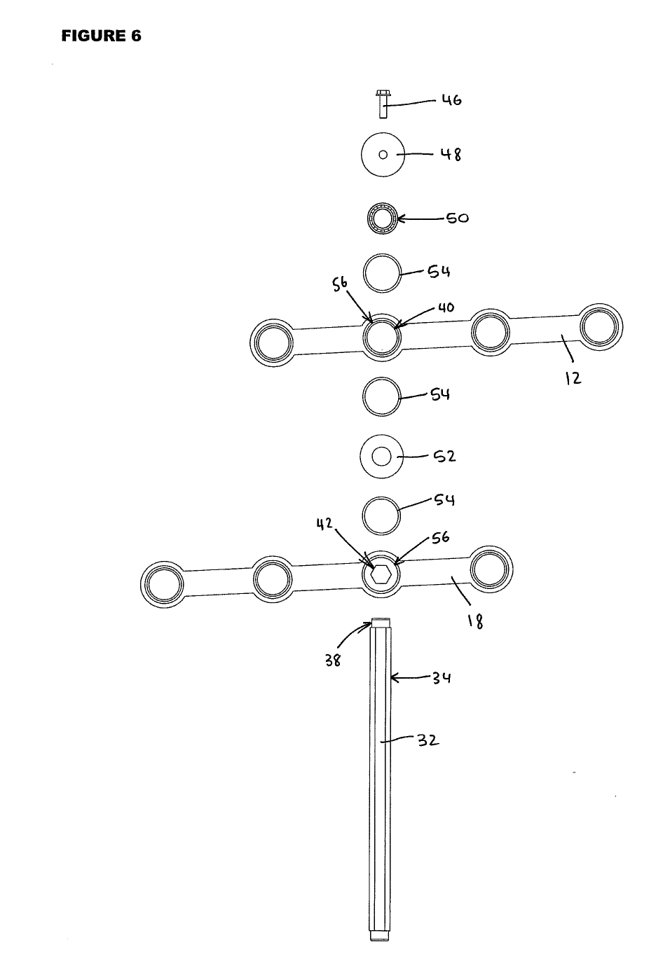

FIG. 6 shows a detailed exploded view of parts forming a step support connecting arrangement of the linkage assembly;

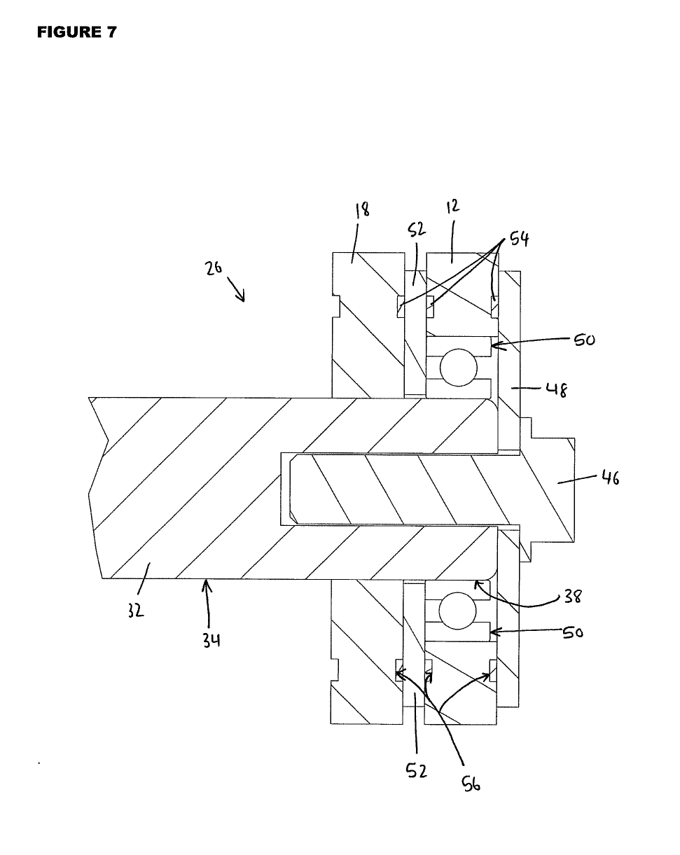

FIG. 7 shows an enlarged partially sectioned view of the step support connecting arrangement;

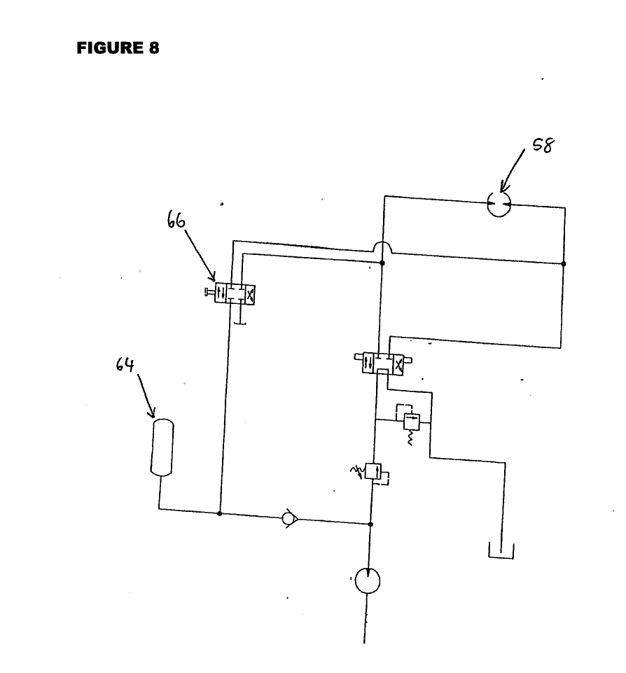

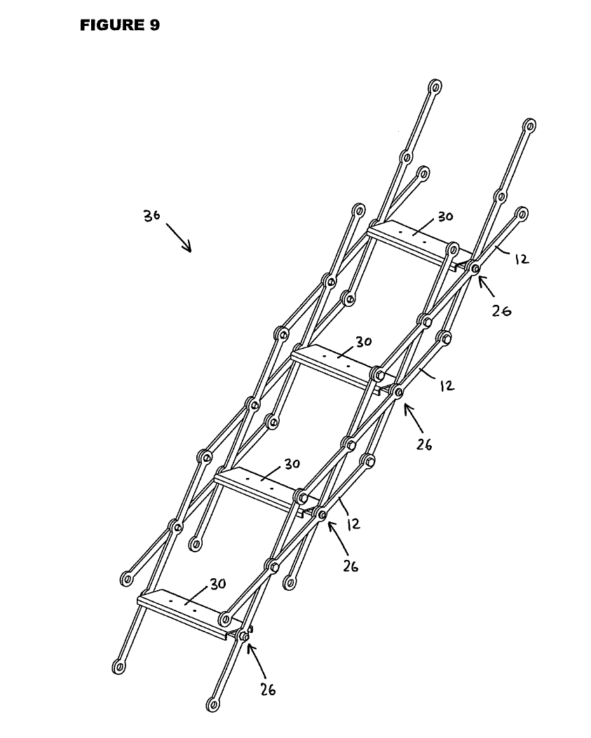

FIG. 8 shows a schematic diagram of a hydraulic circuit of a retractable ladder arrangement;

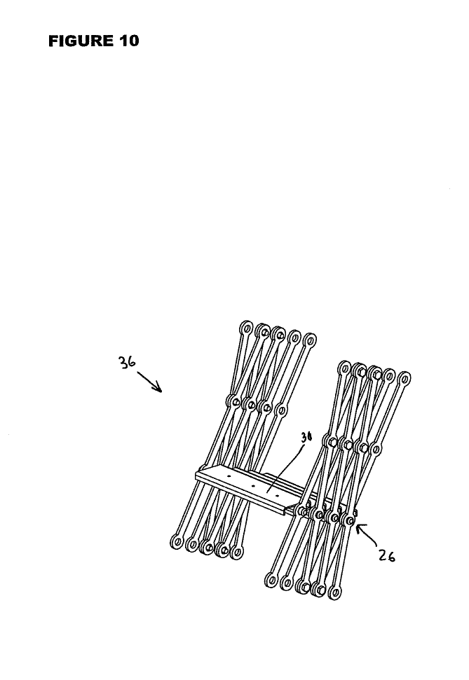

FIGS. 9 and 10 show portions of a retractable ladder in a fully retracted and partially extended condition respectively; and

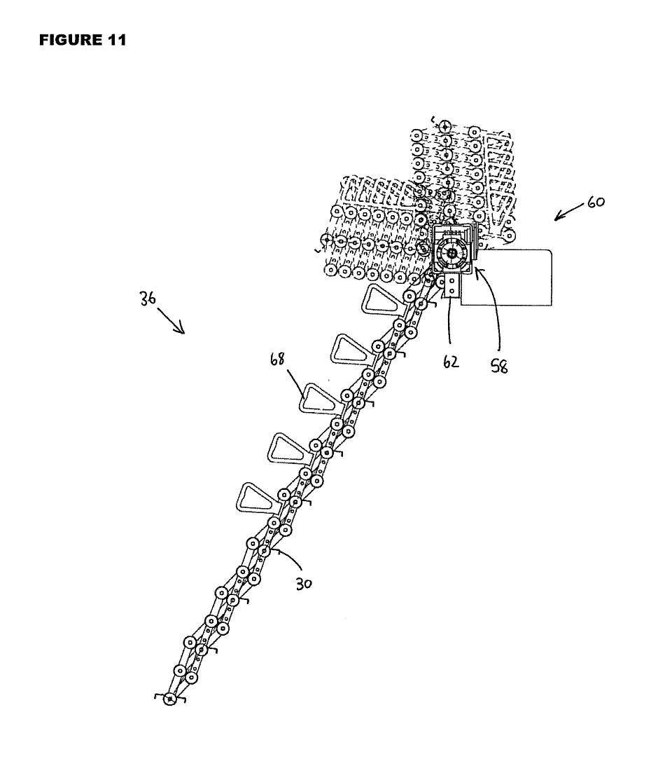

FIG. 11 is a schematic showing the retractable ladder arrangement in a fully extended, retracted and stowed condition respectively.

Referring now to the drawings, and in particular, FIGS. 1 to 7, reference numeral 10 generally depicts a linkage assembly in accordance with the invention which includes first, second, third, fourth and fifth elongate linkage members 12, 14, 16, 18 and 20 respectively, a first connecting arrangement 22 for connecting and allowing pivotal displacement between proximal end regions of the first and second elongate linkage members 12 and 14 respectively, a second connecting arrangement 24 for connecting and allowing pivotal displacement between distal end regions of the first and third elongate linkage members 12 and 16 respectively, a step support connecting arrangement 26 for connecting the first and fourth elongate linkage members 12 and 18 respectively, the step support connecting arrangement 26 being located inwardly the second connecting arrangement 24 and provides a stepping formation 30 for a user, the step support connecting arrangement 26 including a shaft 32 having a first portion 34 which is shaped to be received by and inhibit relative pivotal displacement between the fourth linkage member 18 and the stepping formation 30 during extension and retraction of the retractable ladder arrangement 36 and a second portion 38 shaped to be received by and allow pivotal displacement between the first and fourth linkage members 12 and 18, and a third connecting arrangement 28 for connecting and allowing pivotal displacement between the first and fifth elongate linkage members 12 and 20 respectively, the fifth elongate linkage member 20 being located intermediate the first and step support connecting arrangements 22 and 26 respectively.

The first elongate linkage member 12 includes four receiving formations in the form of circular apertures 40 defined therein for receiving the first, second, third and step support connecting arrangements 22, 24, 28 and 26 respectively, complementally therein. The circular apertures 40 allow pivotal displacement between the first 12 and second 14, first 12 and third 16, first 12 and fourth 18, and first 12 and fifth 20 linkage members respectively.

The second to fifth elongate linkage members 14, 16, 18 and 20 respectively, include three circular apertures 40 and a step support aperture 42 being generally non-circular, typically hexagonal, in cross-section for receiving the first portion 34 of the shaft 32 of the step support connecting arrangement 26. The non-circular step support aperture 34 is configured to inhibit relative displacement between the fourth elongate linkage member 18 and the stepping formation 30.

The first, second and third connecting arrangements 22, 24 and 28 include shaft portions 44 which are configured to be received complementally the apertures 40 in the respective corresponding linkage members 12, 14, 16, 18 and 20 to allow relative pivotal displacement therebetween. The connecting arrangements 22, 24 and 28 further include a retaining member in the form of a screw bolt 46 and washer 48 for retaining the shaft portions 44 in the apertures 40. The connecting arrangements 22, 24 and 28 include bearing assemblies 50 which are shaped and configured to be arranged between the shaft portions 44 and apertures 40 to improve pivotal displacement between the respective linkages and shafts. The connecting arrangements 22, 24 and 28 include spacers in the form of washers or rings 52 for spacing the respective corresponding linkage members apart and to facilitate retention of the bearing assemblies 50 in the apertures 40. The connecting arrangements 22, 24 and 28 further include sealing members in the form of dust seals 54 arranged within corresponding grooves or recesses 56 in the linkage members 12, 14, 16, 18 and 20 surrounding the apertures 40.

The first portion 34 of the shaft 32 of the step support connecting arrangement 26 is configured to be received by the step support aperture 42 of the fourth linkage member 18 and a second portion 38 is configured to be received by the third aperture 40.1 of the first linkage member 12. The first portion 34 of the shaft 32 is of hexagonal cross-section. The first portion 34 is configured to receive securing means in the form of a plurality of bolts (not shown) for securing the stepping formation 30 to the first portion 34 of the shaft 32. The second portion 38 of the shaft 32 is of circular cross-section to permit relative displacement of the first linkage member 12 and the stepping formation 30.

The step support connecting arrangement 26 includes a retaining means in the form of a bolt 46 for retaining the shaft 32 in position in the apertures 40 and 42 of the first and fourth linkage members 12 and 18, respectively. The step support connecting arrangement 26 includes a bearing 50 which is shaped and configured to be arranged between the second portion 38 of the shaft 32 and the aperture 40.1 of the first linkage member 12 to improve pivotal displacement therebetween. The step support connecting arrangement 26 includes a spacer element in the form of a washer or ring 48 for spacing the first and fourth linkage members 12 and 18 apart. The step support connecting arrangement 26 further includes sealing members in the form of dust seals 54 which are manufactured from metal.

Referring now to FIGS. 9 to 11, reference numeral 36 generally depicts a retractable ladder arrangement for a vehicle (not shown), which retractable ladder arrangement 36 includes a plurality of linkage assemblies 10, as hereinbefore described, connected in an end-to-end configuration, a primary displacement means in the form of a motor (not shown) and gearbox 58 for displacing the linkage assemblies 10 between a collapsed retracted condition and an extended condition, a coupling means in the form of a head assembly 60 for coupling the linkage assemblies to the motor (not shown) and gearbox 58 and a controller (not shown) for controlling the primary displacement means.

The motor (not shown) is energised by an energy source from a motor vehicle (not shown). The energy source is in the form of an electricity source (not shown) which provides wither AC or DC current. The head assembly 60 includes a gearbox mounting plate 62 for coupling the gearbox 58 to the linkage assemblies 10.

As shown in FIG. 8, an auxiliary drive means in the form of a pressure vessel 64 is provided for displacing the gearbox 58 in the event that the motor (not shown) is inoperable.

The pressure vessel 64 is arranged in communication with the motor vehicle (not shown) for pressurising the vessel 64 when the vehicle (not shown) is in operation. The pressure vessel 64 includes an activation means in the form of a valve 66 which is activated to drive the gearbox 58 when the motor (not shown) is inoperable. The pressure vessel 64 is coupled to the gearbox 58.

A deactivating means in the form of a pressure sensor (not shown) is provided for deactivating the motor (not shown) and inhibiting displacement of the retractable ladder arrangement 36 when there is a predetermined resistance provided to the displacement of the retractable ladder arrangement 36.

Hand grips 68 are mountable on the linkage members 12, 14, 16, 18 and 20 for assisting a user to climb the ladder arrangement 36 in the extended condition.

Although only certain embodiments of the invention have been described herein, it will be understood by any person skilled in the art that other modifications, variations, and possibilities of the invention are possible. Such modifications, variations and possibilities are therefore to be considered as falling within the spirit and scope of the invention and hence form part of the invention as herein described and/or exemplified.

It shall further be understood that the examples are provided for illustrating the invention further and to assist a person skilled in the art with understanding the invention and is not meant to be construed as unduly limiting the reasonable scope of the invention.

The Applicant believes that a linkage assembly for a retractable ladder in accordance with the invention may be advantageous in that it provides a simple, elegant and effective solution for extending the length of a retractable ladder arrangement to facilitate access to and from a heavy duty mining vehicle or the like.

The Applicant believes it to be a further advantage that the invention provides an auxiliary drive mechanism for extending the ladder arrangement when the motor is inoperable during and emergency.

1. A linkage assembly for a retractable ladder arrangement which includes:
a plurality of elongate linkage members;
a first connecting arrangement for connecting and allowing pivotal displacement between proximal end regions of a first and a second linkage member;
a second connecting arrangement for connecting and allowing pivotal displacement between distal end regions of the first and a third linkage member;
a step support connecting arrangement for connecting the first and a fourth linkage member inwardly the second connecting arrangement and for providing a stepping formation for a user, the step support connecting arrangement including a shaft having a first portion which is shaped to be received by and inhibit relative pivotal displacement between the fourth linkage member and the stepping formation during extension and retraction of the retractable ladder arrangement and a second portion shaped to be received by and allow pivotal displacement between the first and fourth linkage members; and
a third connecting arrangement for connecting and allowing pivotal displacement between the first and a fifth linkage member intermediate the first and step support connecting arrangement.

2. A linkage assembly as claimed in claim 1 wherein the second, third, fourth and fifth elongate linkage members have first, second and third receiving apertures defined therein for receiving the first, second and third connecting arrangements respectively.

3. A linkage assembly as claimed in claim 2 wherein the receiving apertures are of circular sectional form.

4. A linkage assembly as claimed in claim 3 wherein the second, third, fourth and fifth elongate linkage members have a step support aperture defined therein for receiving the first portion of the shaft of step support connecting arrangement therethrough.

5. A linkage assembly as claimed in claim 4 wherein the support aperture is of non-circular sectional form.

6. A linkage assembly as claimed in claim 2, wherein the first, second and third connecting arrangements include shaft portions which are configured to be received complementally the receiving apertures in the respective corresponding linkage members to allow relative pivotal displacement therebetween.

7. A linkage assembly as claimed in claim 6 wherein the connecting arrangements include bearing assemblies which are shaped and configured to be arranged between the shafts and receiving apertures to improve pivotal displacement between the respective linkages and shafts.

8. A linkage assembly as claimed in any one of claim 1, wherein the step support connecting arrangement includes a bearing shaped and configured to be arranged between the second portion of the shaft and the circular apertures of the first linkage member to allow pivotal displacement therebetween.

9. A retractable ladder arrangement for a heavy duty mining vehicle or the like which includes:
a plurality of linkage assemblies as claimed in claim 1 which are connected in an end-to-end configuration;
a primary displacement means for displacing the linkage assemblies between a collapsed retracted condition and an extended condition;
a coupling for coupling the linkage assemblies to the primary displacement means; and
a controller for controlling the primary displacement means.

10. A retractable ladder arrangement as claimed in claim 9 wherein the displacement means includes a motor and gearbox arrangement.

11. A retractable ladder arrangement as claimed in claim 10 wherein a coupling means is provided for coupling the gearbox arrangement to the motor.

12. A retractable ladder arrangement as claimed in claim 11 wherein an auxiliary drive means is coupled to the gearbox arrangement for energizing and displacing the gearbox arrangement when the motor is inoperable.

13. A retractable ladder arrangement as claimed in claim 12 wherein the auxiliary drive means is in the form of a pressure vessel arranged in communication with a motor vehicle for pressurizing the pressure vessel when the motor vehicle is in operation.

14. A retractable ladder arrangement as claimed in claim 9, wherein the controller includes a remote-control member which is located in a position which permits a user access to the remote-control member from a ground surface.

15. A retractable ladder arrangement as claimed in claim 9, which includes hand grips which are mountable on the linkage assemblies.

16. A retractable ladder arrangement as claimed in claim 9 wherein a securing means is provided for securing the ladder arrangement to a vehicle.

17. A retractable ladder arrangement as claimed in claim 9 wherein a secondary displacement means is provided for allowing the ladder arrangement to be displaced pivotally to a stowage position once the ladder arrangement has been displaced to the retracted condition.
